(19) United States
(12) Patent Application Publication
(10) Pub. No.: US 2007/0289907 A1
(43) Pub. Date: Dec. 20, 2007

(54) System and methods for maintaining an aquarium ecosystem

(76) Inventor: Chad VanHulzen, Palatine, IL (US)

Correspondence Address: VALAUSKAS & PINE LLC, Suite 1825, 150 North Wacker Drive, Chicago, IL, 60606, US

(21) Appl. No.: 11/811,582

(22) Filed: Jun. 11, 2007

Related U.S. Application Data
(60) Provisional application No. 60/812,581, filed on Jun. 9, 2006.

(51) Int. Cl. A01K 63/04

(52) U.S. Cl. 210/167.21

(57) ABSTRACT

The present invention is to provide a system and method to maintain an aquarium ecosystem. Maintaining an aquarium ecosystem includes aquarium maintenance, fish feeding, fish care, feeding and caring for invertebrates, plant care, cleaning, etc. The aquarium ecosystem maintenance apparatus has a shaft with a pump and a nozzle. The pump is activated to move liquid or gas into the aquarium through the shaft and out the nozzle. The pump is deactivated to remove solid, liquid or gas from the aquarium through the nozzle and into the shaft.

This application claims the benefit of U.S. Provisional Application No. 60/812,581 filed Jun. 9, 2006.

### FIELD OF THE INVENTION

The present invention relates generally to aquariums, and more particularly to equipment for use in conjunction with aquariums.

### BACKGROUND OF THE INVENTION

Maintaining a healthy ecosystem within an aquarium is essential for the survival of marine and plant life. The interior of the aquarium must be frequently cleaned including changing the water.

A problem faced by aquarists is that the bottom of the aquarium accumulates debris such as fecal matter, vegetable matter, algae, unconsumed food, and various other kinds of waste. Typically, the bottoms of aquariums are layered with gravel. When waste accumulates on the bottom of an aquarium, it begins to break down into toxic chemicals which are harmful to the entire ecosystem, and particularly the fish. It is important to consistently keep the gravel fresh, as well as the entire ecosystem clean and healthy.

There is a need to keep an aquarium ecosystem healthy and aesthetically appealing between water changes. Thus, a system and methods for maintaining a clean and healthy aquarium ecosystem is desired.

### SUMMARY OF THE INVENTION

An object of the present invention is to provide an improved aquarium ecosystem by cleaning the entire aquarium without removing or otherwise disturbing the marine life, or fish. Additionally, aquarium accessories, i.e., plants, corals, rocks, ceramic figurines do not have to be removed from the water tank. The present invention simplifies the process of keeping the aquarium ecosystem clean and healthy between water changes. An aquarium is the enclosure the marine life are kept, such as a tank or bowl, where as an aquarium ecosystem includes the aquarium as well as the environment located therein.

Another object of the present invention is to provide a system and methods for aquarium maintenance, fish feeding, fish care, feeding and caring for invertebrates, plant care, cleaning, etc.

Another object of the present invention is to provide a system and methods to stir, agitate, blast or remove all debris accumulated within the aquarium, for example, on the bottom or sides of the aquarium, or within the gravel. The present invention can be used to remove algae adhering to any aquarium surface or aquarium accessory, i.e., plants, corals, rocks, ceramic figurines. The present invention brings debris to the water surface and through the filter, or skimmer. The present invention allows the filter to polish and sanitize the water.

Another object of the present invention is the use of forced gas, or air, to oxygenate the aquarium ecosystem.

Another object of the present invention is to circulate “dead spots”, or areas of low or no current, within the aquarium ecosystem. Typically “dead spots” exist in corners, caves, etc.

Yet another object of the present invention is to retrieve and remove all debris accumulated within the aquarium ecosystem, for example, on the bottom or sides of the aquarium, or within the gravel. The present invention can siphon, or suction, to remove algae adhering to any aquarium surface or aquarium accessory, i.e., plants, corals, rocks, ceramic figurines. Siphoning assists in bringing the debris into the apparatus of the present invention for removal from the aquarium ecosystem. In addition, siphoning can be used to suck up food as well as dispense food to feed fish, invertebrates and live corals.

The present invention will be further appreciated, and its attributes and advantages further understood, with reference to the detailed description below of some presently contemplated embodiments, taken in conjunction with the accompanying drawings, in which:

### BRIEF DESCRIPTION OF THE DRAWINGS

FIG. 1 is a perspective view of an embodiment of an aquarium ecosystem maintenance apparatus according to the present invention; and

FIG. 2 is a perspective view of an alternate embodiment of an aquarium ecosystem maintenance apparatus according to the present invention.

### DETAILED DESCRIPTION OF EMBODIMENTS OF THE INVENTION

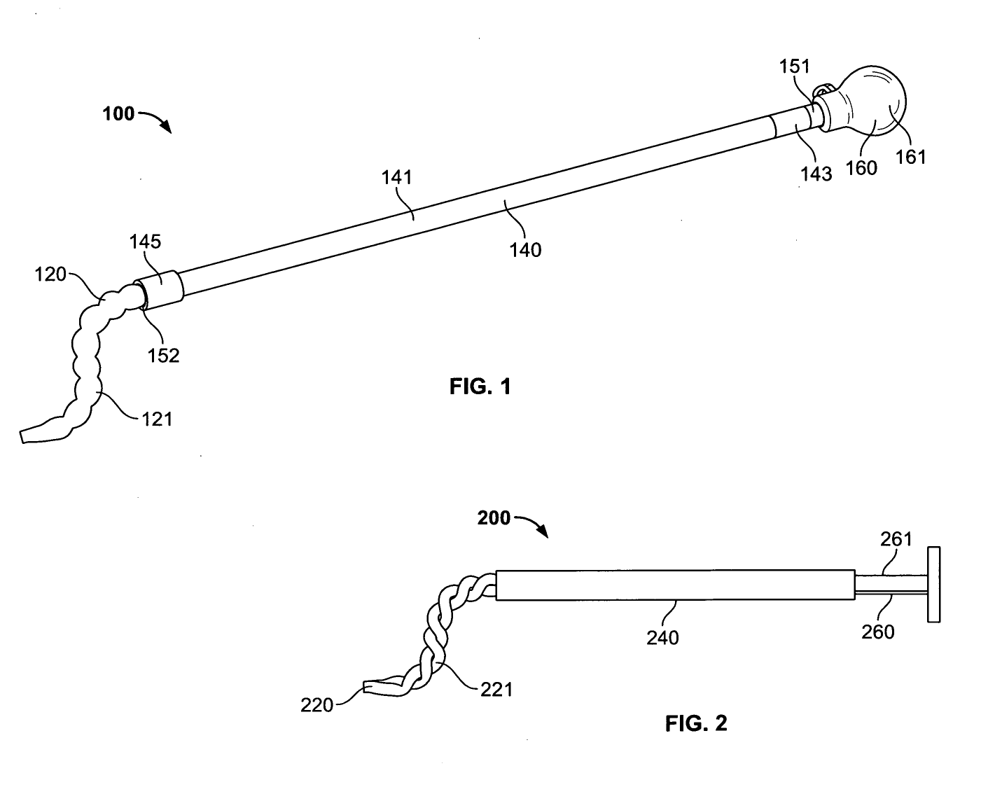

FIG. 1 is a perspective view of an embodiment of an aquarium ecosystem maintenance apparatus 100 according to the present invention. The apparatus 100 comprises three main components: nozzle 120, shaft 140 and pump 160.

The pump 160 is used to introduce, or move, liquid or gas into the aquarium ecosystem as well as remove solid, liquid or gas from the aquarium ecosystem. Any type of pump 160 is contemplated, for example, pump 160 may be a squeeze bulb, piston pump, plunger or any hand pump (see the alternate embodiment of FIG. 2 described more fully below). It is further contemplated that the present invention can be electrically powered, for example, an automatic pump. It is also contemplated that the apparatus can be battery powered.

The pump 160 of FIG. 1 is a bulb 161. The bulb 161 is made of rubber, although any material is contemplated. The bulb 161 can be activated, such as compressed or squeezed, to move liquid or gas through the shaft 140 and out the nozzle 120 into the aquarium ecosystem. The bulb 161 can also be deactivated, such as decompressed, to remove solid, liquid or gas from the aquarium ecosystem through the nozzle 120 and into the shaft 140. As shown in FIG. 1, the bulb 161 is spherical in shape, but any shape is contemplated.

The shaft 140 is used to access the interior of the aquarium. The shaft 140 can be any length, and even adjustable or telescoping, to reach into aquariums of various depths and dimensions. Additionally, the shaft 140 can be of any size, thickness and diameter. The shaft 140 is made of plastic, although any material is contemplated that is suitable material to withstand elements of the aquarium ecosystem, including salt water. As shown in FIG. 1, the shaft 140 is a cylindrical tube 141 with a first end 143 and a second end 145. The pump 160 is connected to the first end 143 of the shaft 140 by a connecting element 151.

A second end 145 of the shaft 140 is connected to a nozzle 120 via connecting element 152. The nozzle 120 is made of any suitable material, such as plastic. The nozzle 120 can be of any size and shape. It is contemplated that the nozzle 120 can have various configurations such as flat, wide, narrow, etc. For example, the nozzle 120 can include a flat edge for scraping aquarium glass while stirring, agitating, blasting or removing debris from the ecosystem. As shown in FIG. 1, the nozzle 120 is a flexible projection 121 for easy function and to reach intricate places within the aquarium. The nozzle 120 accurately directs the movement of liquid or gas through the shaft 140 and out the nozzle 120.

It is also contemplated the nozzle 120 can be an accessory, such as a flat scraper, poker, pincher, grabber, suction cup or any attachment that can be helpful in maintaining a clean and healthy aquarium ecosystem.

Connecting element 151 unifies the first end 143 of the shaft 140 to the pump 160, and connecting element 152 unifies the second end 145 of the shaft 140 to the nozzle 120. Connecting elements 151, 152 are any connection contemplated to secure the apparatus 100 during operation, for example threaded, snap fit, or sonic welded, to name a few.

In order to stir, agitate, blast or remove all debris accumulated within the aquarium ecosystem, the pump 160 is activated to move liquid or gas through the shaft 140 and out the nozzle 120. For example, to remove algae from coral, the nozzle 120 is manipulated to be directed at the desired area of removal. As shown in FIG. 1, the pump 160 is activated, such as the bulb 161 is squeezed, to move liquid or gas into the aquarium through the cylindrical tube 141 and out the flexible projection 121. Once the liquid or gas is moved out the nozzle 120, the pump 160 is deactivated such that the apparatus 100 can repeat, if desired, the moving of liquid or gas through the shaft and out the nozzle.

It is contemplated that apparatus 100 can be operated either when the nozzle 120 is positioned inside the aquarium, i.e., submerged in water, or positioned outside the aquarium prior to submerging the nozzle 120.

In the embodiment shown in FIG. 1, the force applied to the bulb 161 dictates the strength, or power, of the movement of liquid or gas through cylindrical tube 141 and out the flexible projection 121, for example, squeezing the bulb 161 hard for a powerful movement of liquid or gas into the aquarium through cylindrical tube 141 and out the flexible projection 121, or squeezing the bulb 161 softer for a less powerful movement of liquid or gas into the aquarium through cylindrical tube 141 and out the flexible projection 121.

In order to siphon debris for removal from the aquarium, after the pump 160 is activated to move liquid or gas into the aquarium through the shaft 140 and out the nozzle 120, the pump 160 is deactivated, which creates a vacuum at the nozzle 120. The vacuum siphons debris, for example fallen food. For example, to remove debris from an aquarium the pump bulb 161 is compressed while the cylindrical tube 141 and flexible projection 121 are positioned outside the aquarium, the apparatus 100 is then placed within the aquarium and substantially near the debris to be siphoned. The bulb 161 is expanded to remove the debris, or solid, and even liquid or gas from the aquarium through the nozzle 120 and into the shaft 140.

An alternate embodiment of the aquarium ecosystem maintenance apparatus 200 is illustrated in FIG. 2. The apparatus 200 comprises three main components: nozzle 220, shaft 240 and pump 260. As shown in FIG. 2, the shaft 240 is a duct 241, and the nozzle 220 is an S-shaped conduit 221. The pump 260 of FIG. 2 is a plunger 261, such that the plunger 261 is activated, by pushing the plunger 261 inward toward the shaft 240, to move liquid or gas into the aquarium through the duct 241 and out the conduit 221. Likewise, as discussed above, the plunger 261 can be deactivated, by drawing the plunger 261 away from the shaft 240, to remove or siphon solid, liquid or gas from the aquarium through the conduit 221 and into the duct 241.

Thus, while a multitude of embodiments have been variously described herein, those of skill in this art will recognize that different embodiments show different potential features/designs which can be used in the other embodiments. Even more variations, applications and modifications will still fall within the spirit and scope of the invention, all as intended to come within the ambit and reach of the following claims.

What is claimed is:

1. An aquarium ecosystem maintenance apparatus, comprising:
a shaft with a first end and second end;
a nozzle, wherein a first connecting element unifies said nozzle to said second end of said shaft; and
a pump, wherein a second connecting element unifies said pump to said first end of said shaft, wherein said pump is activated to move liquid or gas into the aquarium through said shaft and out said nozzle.

2. An aquarium ecosystem maintenance apparatus, comprising:
a shaft with a first end and second end;
a nozzle, wherein a first connecting element connects said nozzle to said second end of said shaft; and
a pump, wherein a second connecting element connects said pump to said first end of said shaft, wherein said pump is deactivated to move solid, liquid or gas from the aquarium through said nozzle and into said shaft.

3. A method of maintaining an aquarium ecosystem, comprising:
providing an apparatus including a pump, shaft and nozzle;
activating said pump;
moving liquid or gas into the aquarium through said shaft and out said nozzle;
deactivating said pump; and
removing solid, liquid or gas from the aquarium through said nozzle and into said shaft.
